(19) United States
(12) Patent Application Publication
(10) Pub. No.: US 2004/0243653 A1
(43) Pub. Date: Dec. 2, 2004

(54) System and method for generating an alarm when an abnormal database backup status occurs

(76) Inventors: Chung-I Lee, Tu-chen (TW); Yi Guo Wang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/859,416

(22) Filed: Jun. 1, 2004

(30) Foreign Application Priority Data
May 30, 2003 (TW) 92114846

(51) Int. Cl. G06F 17/30

(52) U.S. Cl. 707/204

(57) ABSTRACT

A system for generating an alarm when an abnormal database backup status occurs includes an alarm module (121) for determining whether an abnormal database backup status exists, and generating and transmitting an alarm message and an alarm email. The alarm module includes a scan sub-module (1211), an alarm message sub-module (1212), an alarm mail sub-module (1213), and a log file sub-module (1214). The scan sub-module is used for scanning the database to identify whether an abnormal backup status exists, wherein the abnormal backup status means that the free space of the database is not enough for storing backup files. The alarm message sub-module is used for sending the alarm message. The alarm mail sub-module is used for sending the alarm email. The log file sub-module is used for recording the abnormal backup status. A related method for generating an alarm when an abnormal database backup status occurs is also provided.

### BACKGROUND OF THE INVENTION

1. Field of the Invention

The present invention relates to computerized systems and methods for facilitating administrators to supervise database backup, and particularly to a system and method which can generate an alarm when an abnormal database backup status occurs.

2. Prior Art of the Invention

For facilitating administrators to supervise database backup in an enterprise, a database management system (DBMS) provides functions for emailing/sending appropriate alarms to the administrators. The alarms can help administrators to timely rectify any abnormal statuses. Nevertheless, a typical DBMS generally provides alarms that are emailed/sent via the Internet only, rather than via the internal network of the enterprise. This is because the transmission protocol/format of the internal network generally differs from enterprise to enterprise.

The art of facilitating administrators to supervise database backup is disclosed in patents such as U.S. Pat. No. 6,324,548 issued on Nov. 27, 2001 and entitled “Database Backup and Recovery Using Separate History Files for Database Backup and Audit Backup.” This patent discloses a system for using separate history files to record timestamps of database backups for facilitating administrators to manage backup copy files in a backup copy database by reading the backup history in separate history files. However, the system does not provide functions for facilitating administrators to timely rectify abnormal statuses. What is needed is a system and method that provides functions for sending alarms to advise administrators of the need to rectify abnormalities.

### SUMMARY OF THE INVENTION

A main objective of the present invention is to provide a system and method which can generate an alarm when an abnormal database backup status occurs in order to facilitate administrators in supervising database backup.

To accomplish the above objective, a system for generating an alarm when an abnormal database backup status occurs in accordance with a preferred embodiment of the present invention comprises an alarm module, an alarm receiving module, a server mail module, and a client mail module. The alarm module is used for determining whether an abnormal database backup status exists, and generating and transmitting an alarm message to a client computer and an alarm email to the mail server. The alarm module comprises a scan sub-module, an alarm message sub-module, an alarm mail sub-module, and a log file sub-module. The scan sub-module is used for scanning the database to identify whether the database has an abnormal backup status. An abnormal backup status means that the free space of the database is not enough for storing files that need to be backed up. The alarm message sub-module connects to the scan sub-module, for transmitting an alarm message to the alarm receiving module when the scan sub-module determines that the free space of the database is not enough for storing the backup files. Under this circumstance, the alarm mail sub-module, which is also connected to the scan sub-module, transmits an alarm email to the server mail module. The log file sub-module is used for recording the database backup status.

The present invention also provides a method for generating an alarm when an abnormal database backup status occurs. The method comprises the steps of: (1) scanning free space of a database for determining whether the free space is enough for backup; (2) sending an alarm message to a client computer and sending an alarm email to a mail server if the free space is not enough for backup; and (3) recording a database backup status in a log file.

Other objects, advantages and novel features of the present invention will be drawn from the following detailed description of the preferred embodiment and a preferred method of the present invention with the attached drawings, in which:

### BRIEF DESCRIPTION OF THE DRAWINGS

FIG. 1 is a schematic diagram of hardware configuration of a system for generating an alarm when an abnormal database backup status occurs in accordance with the preferred embodiment of the present invention;

FIG. 2 is a block diagram showing main software function modules of the system of FIG. 1;

FIG. 3 is a schematic diagram showing main software function sub-modules of an alarm module of a database server shown in FIG. 2; and

FIG. 4 is a flowchart of the preferred method for generating an alarm when an abnormal database backup status occurs according to the present invention.

### DETAILED DESCRIPTION OF THE INVENTION

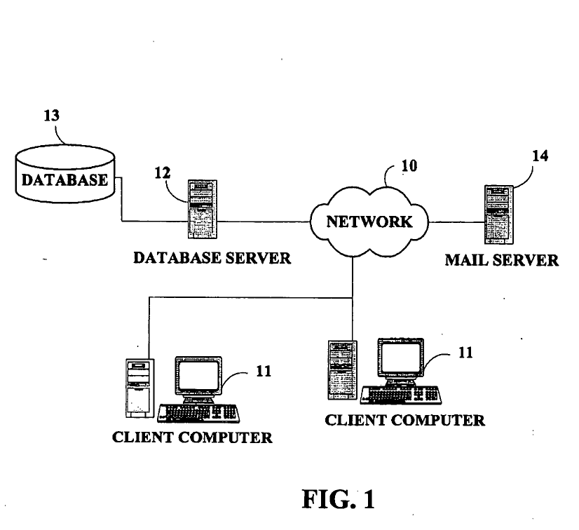

FIG. 1 is a schematic diagram of hardware configuration of a system for generating an alarm when an abnormal database backup status occurs (hereinafter, “the system”) in accordance with the preferred embodiment of the present invention. The system comprises a database server 12, a mail server 14, and a plurality of client computers 11 connected to the database server 12 and the mail server 14 via a network 10. The database server 12 is used for visiting, backup, and recovery of a database 13 linked thereto. The mail server 14 is used for facilitating email management of an enterprise operating the system. The client computers 11 are used for facilitating administrators and operators of the system to obtain emails from the mail server 14.

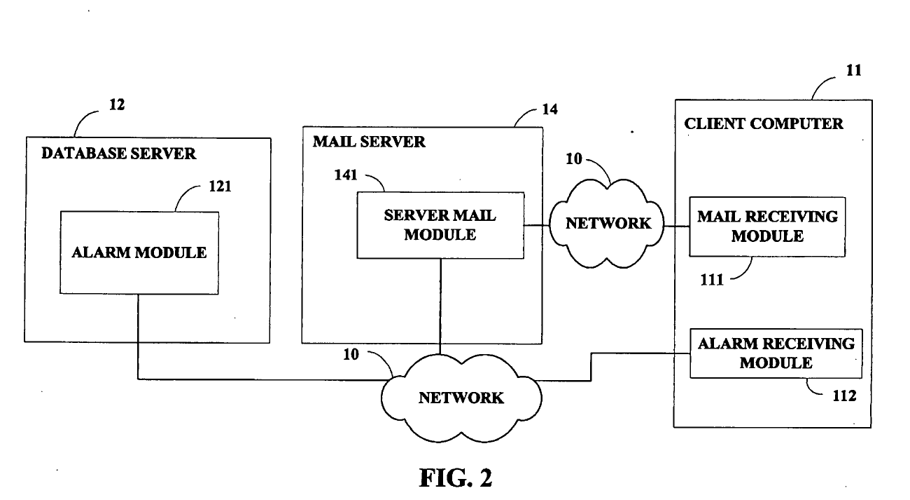

FIG. 2 is a block diagram showing main software function modules of the system. The database server 12 comprises an alarm module 121. The mail server 14 comprises a server mail module 141. Each client computer 11 comprises a mail receiving module 111 and an alarm receiving module 112. The alarm module 121 is used for scanning of free space of the database 13 before storing backup files. If the free space is not enough for storing the backup files, the alarm module 121 generates an alarm message and an alarm email, and transmits the alarm message to the alarm receiving module 112 and the alarm email to the server mail module 141 via the network 10. The alarm message is in data stream format, and the alarm email is in a standard electronic mail format. The alarm module 121 further records a database backup status into a log file. The log file typically comprises a start time and an end time of each database backup, information on whether an abnormal backup status occurred, and a description of each abnormal backup status that occurred. The alarm receiving module 112 is provided by the client computer 11 for receiving the alarm message. The server mail module 141 connects to the alarm receiving module 121 and the mail receiving module 111 via the network 10, for receiving the alarm email from the alarm module 121, and for transmitting the alarm email to the mail receiving module 111.

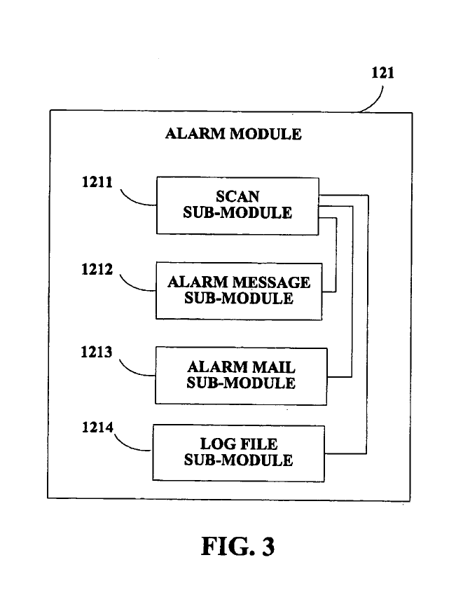

FIG. 3 is a schematic diagram showing main software function sub-modules of the alarm module 121. The alarm module 121 comprises a scan sub-module 1211, an alarm message sub-module 1212, an alarm mail sub-module 1213, and a log file sub-module 1214. The scan sub-module 1211 is used for scanning the database 13 to identify whether the database 13 has an abnormal backup status. An abnormal backup status means that the free space of the database 13 is not enough for storing files that need to be backed up. The alarm message sub-module 1212 connects to the scan sub-module 1211, for transmitting an alarm message to the alarm receiving module 112 when the scan sub-module 1211 determines that the free space of the database 13 is not enough for storing the backup files. Under this circumstance, the alarm mail sub-module 1213, which is also connected to the scan sub-module 1211, transmits an alarm email to the server mail module 141. The log file sub-module 1214 is used for recording the database backup status.

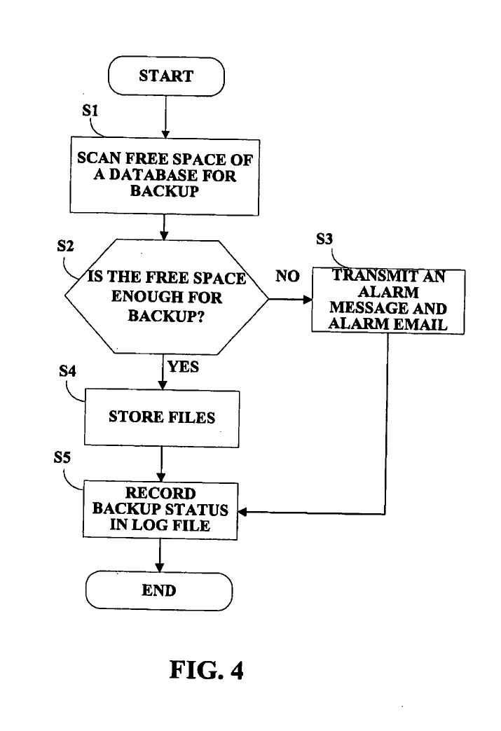

FIG. 4 is a flowchart of the preferred method for generating an alarm when an abnormal database backup status occurs according to the present invention, which is performed utilizing the system. In step S1, the scan sub-module 1211 scans free space of the database 13 available for storing backup files. In step S2, the alarm module 121 determines whether the free space is enough for storing the backup files. If the free space is not enough for storing the backup files, in step S3, the alarm message sub-module 1212 transmits an alarm message to a corresponding client computer 11. Simultaneously, the alarm mail sub-module 1213 transmits an alarm email to the mail server 14. The procedure then goes to step S5 described below. If the free space is enough for storing the backup files, in step S4, the system stores the backup files in the database 13, whereupon the procedure goes to step S5. In step S5, the log file sub-module 1214 records the database backup status in a log file.

Although the present invention has been specifically described on the basis of a preferred embodiment and preferred method, the invention is not to be construed as being limited thereto. Various changes or modifications may be made to said embodiment and method without departing from the scope and spirit of the invention.

What is claimed is:

1. A system for generating an alarm when an abnormal database backup status occurs, the system comprising a database server, a mail server, and a plurality of client computers, wherein the database server comprises:
an alarm module for scanning of free space of a database associated with the database server, and generating and transmitting an alarm message to at least one of the client computers and an alarm email to the mail server when the free space of the database is not enough for storing the backup files, the alarm module comprising:
a scan sub-module for scanning the database to identify whether the free space of the database is enough for storing the backup files;
an alarm message sub-module for transmitting the alarm message to said at least one of the client computers when the free space is not enough for storing the backup files;
an alarm mail sub-module for transmitting the alarm email to the mail server; and
a log file sub-module for recording a database backup status.

2. The system according to claim 1, wherein the mail server comprises a server mail module for receiving the alarm email from the alarm module of the database server.

3. The system according to claim 1, wherein each of the client computers comprises an alarm receiving module for receiving the alarm message from the alarm module of the database server, and a mail receiving module for receiving the alarm email from the mail server.

4. A method for generating an alarm when an abnormal database backup status occurs, the method comprising the steps of:
scanning free space of a database and determining whether the free space is enough for storing backup files;
transmitting an alarm message to a corresponding client computer and an alarm email to a mail server, if the free space is not enough for storing the backup files; and
recording a database backup status in a log file.

5. The method according to claim 4, further comprising the step of:
storing the backup files in the database, if the free space is enough for storing the backup files.

6. The method according to claim 4, wherein the database backup status recorded in the log file is an abnormal backup status, if the free space is not enough for storing the backup files.
